(19) United States
(12) Patent Application Publication
(10) Pub. No.: US 2016/0004988 A1
(43) Pub. Date: Jan. 7, 2016

(54) METHODS FOR CALCULATING A CUSTOMER SATISFACTION SCORE FOR A KNOWLEDGE MANAGEMENT SYSTEM AND DEVICES THEREOF

(71) Applicant: Wipro Limited, Bangalore (IN)

(72) Inventors: Sreenivas Kunapuli, Hyderabad (IN); Anuradha Pentareddy, Hyderabad (IN)

(21) Appl. No.: 14/466,432

(22) Filed: Aug. 22, 2014

(30) Foreign Application Priority Data
Jul. 7, 2014 (IN) 3342/CHE/2014

(51) Int. Cl. G06Q 10/06

(52) U.S. Cl. CPC G06Q 10/06393

(57) ABSTRACT

A method, non-transitory computer readable medium, and device that calculates a customer satisfaction score for a knowledge management system includes calculating a knowledge artifact score for a plurality of knowledge artifacts obtained from an overall set of knowledge artifacts, based on at least one of a newness value or a utility value for each of the plurality of the knowledge artifacts. Subsequently, a customer satisfaction index for the plurality of knowledge artifacts obtained from the overall set of knowledge artifacts is determined based on at least a knowledge artifact quality and a customer artifact experience. Next a customer feedback score is determined based on at least a knowledge management system performance score and a customer system experience score. A total customer satisfaction score for the knowledge management system is then calculated based on the calculated knowledge artifact score, the determined customer satisfaction index and the determined customer feedback score.

This application claims the benefit of Indian Patent Application No. 3342/CHE/2014 filed Jul. 7, 2014, which is hereby incorporated by reference in its entirety.

### FIELD

This disclosure generally relates to methods and devices for assessing the efficacy and maturity of a knowledge management system and, more specifically, to a method for calculating a customer satisfaction score for a knowledge management system and devices thereof.

### BACKGROUND

With the continuing advancements in digital technologies and communications, individuals can now communicate and exchange information with each other in numerous ways which has led to huge influx of information to an individual from different sources. As a result, individuals can now easily be lost in this sea of knowledge. As a result of this new dynamic, it is becoming increasingly more important to understand and manage this vast amount of knowledge. Currently, there are a number of tools available in the market today that implement Knowledge Management. To manage all of the available information, more and more organizations are acquiring and implementing these Knowledge Management tools. Unfortunately, most of these Knowledge Management tools are simply a means for storing and retrieving knowledge and provide little if any assistance with feedback on how effective managing knowledge is from the perspective of an end user or customer. As a result, even in organizations that have acquired and implemented Knowledge management tools to assist, these organization have no real knowledge how difficult it is for their end users to access the relevant information, to interact with other end users, and/or to share knowledge among end users.

Information on the effectiveness of knowledge management is a particular area of concern for product companies. If a customer of a product company is not able to easily and readily access relevant information from a vast amount of available information, then the product company may lose that customer. Statistics quote that more than 80% of the customers may back out from a potential product purchase based on a single bad experience.

Examples of difficulties customers of product companies may face may include problems with interacting with other users of the same product they are interested. Another example is difficulties with being able to share their views or feedback on a product. These and many other issues with Knowledge Management can occur throughout the entire cycle of purchasing a product, leading to lost customers and low customer satisfaction with the product company and its offerings or services.

### SUMMARY

A method for calculating customer satisfaction score for a knowledge management system comprises calculating, at the knowledge management data server device, a knowledge artifact score for a plurality of knowledge artifacts obtained from an overall set of knowledge artifacts, based on at least one of a newness value or a utility value for each of the plurality of the knowledge artifacts. Subsequently, a customer satisfaction index for the plurality of knowledge artifacts obtained from the overall set of knowledge artifacts is determined based on at least a knowledge artifact quality and a customer artifact experience. Next a customer feedback score for the knowledge management system is determined based on at least a knowledge management system performance score and a customer system experience score. A total customer satisfaction score for the knowledge management system is then calculated based on the calculated knowledge artifact score for the plurality of knowledge artifacts, the determined customer satisfaction index for the plurality of knowledge artifacts and the determined customer feedback score for the knowledge management system.

A non-transitory computer readable medium having stored thereon instructions for calculating customer satisfaction score for a knowledge management system, comprising machine executable code which when executed by a processor, causes the processor to perform steps comprising, calculating a knowledge artifact score for a plurality of knowledge artifacts obtained from an overall set of knowledge artifacts, based on at least one of a newness value or a utility value for each of the plurality of the knowledge artifacts. Subsequently, a customer satisfaction index for the plurality of knowledge artifacts obtained from the overall set of knowledge artifacts is determined based on at least a knowledge artifact quality and a customer artifact experience. Next a customer feedback score for the knowledge management system is determined based on at least a knowledge management system performance score and a customer system experience score. A total customer satisfaction score for the knowledge management system is then calculated based on the calculated knowledge artifact score for the plurality of knowledge artifacts, the determined customer satisfaction index for the plurality of knowledge artifacts and the determined customer feedback score for the knowledge management system.

A knowledge management computing device, comprising a memory and a processor coupled to the memory and configured to execute programmed instructions stored in the memory comprising, calculating a knowledge artifact score for a plurality of knowledge artifacts obtained from an overall set of knowledge artifacts, based on at least one of a newness value or a utility value for each of the plurality of the knowledge artifacts. Subsequently, a customer satisfaction index for the plurality of knowledge artifacts obtained from the overall set of knowledge artifacts is determined based on at least a knowledge artifact quality and a customer artifact experience. Next a customer feedback score for the knowledge management system is determined based on at least a knowledge management system performance score and a customer system experience score. A total customer satisfaction score for the knowledge management system is then calculated based on the calculated knowledge artifact score for the plurality of knowledge artifacts, the determined customer satisfaction index for the plurality of knowledge artifacts and the determined customer feedback score for the knowledge management system.

It is to be understood that both the foregoing general description and the following detailed description are exemplary and explanatory only and are not restrictive of the invention, as claimed.

### BRIEF DESCRIPTION OF DRAWINGS

FIG. 1 is a block diagram of an exemplary environment with the knowledge management computing device configured to calculate customer satisfaction score for a knowledge management system;

FIG. 2 is a block diagram of the exemplary knowledge management computing device illustrated in FIG. 1; and

FIG. 3 is a flow chart of an example of a method for calculating customer satisfaction score for a knowledge management system in accordance with some embodiments.

### DETAILED DESCRIPTION

Now, exemplary embodiments of the present disclosure will be described with reference to the accompanying drawings. Wherever possible, the same reference numbers will be used throughout the drawings to refer to the same or like parts. While exemplary embodiments and features are described herein, modifications, adaptations, and other implementations are possible, without departing from the spirit and scope of the disclosure. Accordingly, the following detailed description does not limit the subject matter. Instead, the proper scope of the subject matter is defined by the appended claims.

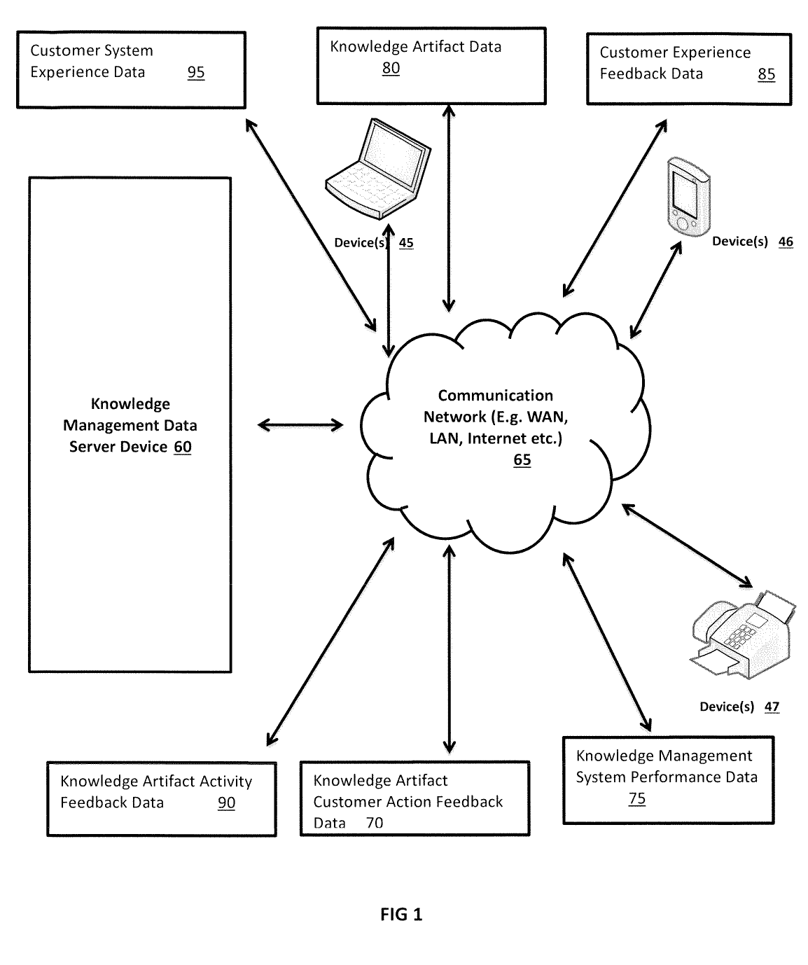

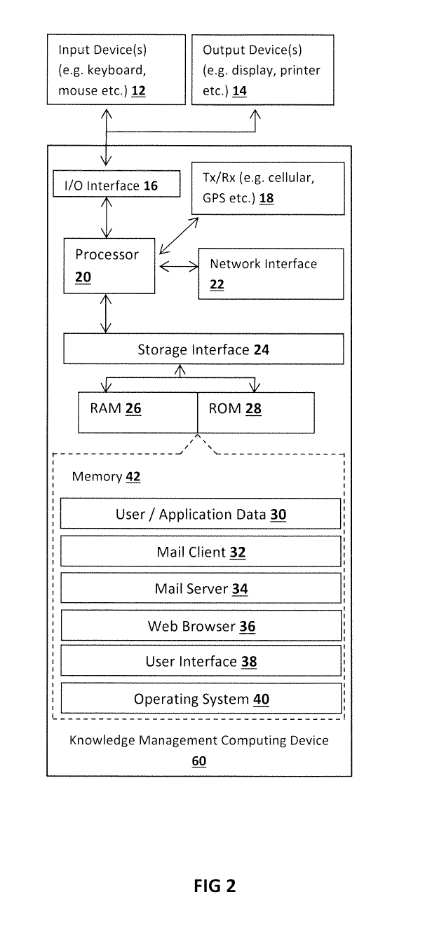

FIG. 1 is a diagram of an exemplary environment with a knowledge management computing device 60 configured to calculate the customer satisfaction score for a knowledge management system. The knowledge management computing device is one of the possible variations of the knowledge management computing device 60 described in greater detail below with reference to FIG. 2. The example of an environment described here includes the knowledge management computing device 60 being connected to the communication network 65 in a variation of some of the mentioned methods described in greater detail herein with reference to FIG. 2. The knowledge management computing device 60 is further connected to multiple knowledge artifact and system level data sources like the knowledge artifact customer action feedback data source 70, knowledge management system performance data source 75, knowledge artifact data source 80, customer experience feedback data source 85, knowledge artifact activity feedback data source 90, and customer system experience data source 95 received by the knowledge management system itself, through the communication network 65, although the knowledge management computing device 60 could be connected to other types and/or numbers of sources. The knowledge management computing device 60 then receives through the communication network 65, data regarding the various aspects of the knowledge artifacts, customer experience and system performance by way of example only from one or more of the above mentioned multiple data sources upon which the knowledge artifact score, the customer satisfaction index and customer feedback score are calculated. This data is further analyzed by the knowledge management computing device 60 and a total customer satisfaction score for the knowledge management system is calculated, which is based on the calculated knowledge artifact score for the plurality of knowledge artifacts, the determined customer satisfaction index for the plurality of knowledge artifacts and the determined customer feedback score for the knowledge management system.

FIG. 2 is a block diagram of an example of the knowledge management computing device 60 configured to calculate the customer satisfaction score for a knowledge management system, although other types and/or numbers of other computer devices or other systems could be used as a knowledge management computing device. Knowledge management computing device 60 may comprise a central processing unit (“CPU” or “processor”) 20. Processor 20 may comprise at least one data processor for executing program components for executing user- or system-generated requests. A user may include a person, a person using a device, such as such as those included in this disclosure, or such a device itself. The processor 20 may include specialized processing units such as integrated system (bus) controllers, memory management control units, floating point units, graphics processing units, digital signal processing units, by way of example only. The processor 20 may include a microprocessor, such as AMD Athlon, Duron or Opteron, ARM's application, embedded or secure processors, IBM PowerPC, Intel's Core, Itanium, Xeon, Celeron or other line of processors, by way of example only. The processor 20 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), by way of example only.

Processor 20 may be disposed in communication with one or more input/output (I/O) devices via I/O interface 16. The I/O interface 16 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), by way of example only.

Using the I/O interface 16, the knowledge management computing device 60 may communicate with one or more I/O devices. For example, the input device 12 may be an antenna, keyboard, mouse, joystick, (infrared) remote control, camera, charge-coupled device (CCD), card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, by way of example only. Output device 14 may be a printer, fax machine, video display (e.g., cathode ray tube (CRT), liquid crystal display (LCD), light-emitting diode (LED), plasma, or the like), audio speaker, by way of example only. In some embodiments, a transceiver 18 may be disposed in connection with the processor 20. The transceiver 18 may facilitate various types of wireless transmission or reception. For example, the transceiver 18 may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, by way of example only.

In some embodiments, the processor 20 may be disposed in communication with a communication network 65 via a network interface 22. The network interface 22 may communicate with the communication network 65. The network interface 22 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, by way of example only. The communication network 65 may include, without limitation, a direct interconnection, local area network (LAN), wide area network (WAN), wireless network (e.g., using Wireless Application Protocol), the Internet, by way of example only. Using the network interface 22 and the communication network 65, the knowledge management computing device 60 may communicate with one or more devices 45, 46, and 47, although other types and/or numbers of other devices and/or systems could be connected. These devices may include, without limitation, personal computer(s), server(s), fax machines, printers, scanners, various mobile devices such as cellular telephones, smartphones (e.g., Apple iPhone, Blackberry, Android-based phones, by way of example only.), tablet computers, eBook readers (Amazon Kindle, Nook, by way of example only.), laptop computers, notebooks, gaming consoles (Microsoft Xbox, Nintendo DS, Sony PlayStation, by way of example only.), or the like. In some embodiments, the knowledge management computing device 60 may itself embody one or more of these devices.

In some embodiments, the processor 20 may be disposed in communication with one or more memory devices (e.g., RAM 26, ROM 28, by way of example only.) via a storage interface 24. The storage interface 24 may connect to memory devices including, without limitation, memory drives, removable disc drives, by way of example only, employing connection protocols such as serial advanced technology attachment (SATA), integrated drive electronics (IDE), IEEE-1394, universal serial bus (USB), fiber channel, small computer systems interface (SCSI), by way of example only. The memory drives may further include a drum, magnetic disc drive, magneto-optical drive, optical drive, redundant array of independent discs (RAID), solid-state memory devices, solid-state drives, by way of example only.

The memory devices comprise a memory 42 that may store a collection of program, database components, and/or other data including, by way of example only and without limitation, an operating system 40, user interface application 38, web browser 36, mail server 34, mail client 32, user/application data 30 (e.g., any data variables or data records discussed in this disclosure), although other types and/or numbers of other programmed instructions, modules, and/or other data may be stored The operating system 40 may facilitate resource management and operation of the knowledge management computing device 60. Examples of operating systems include, without limitation, Apple Macintosh OS X, Unix, Unix-like system distributions (e.g., Berkeley Software Distribution (BSD), FreeBSD, NetBSD, OpenBSD, by way of example only.), Linux distributions (e.g., Red Hat, Ubuntu, Kubuntu, by way of example only.), IBM OS/2, Microsoft Windows (XP, Vista/7/8, by way of example only.), Apple iOS, Google Android, Blackberry OS, or the like. User interface 38 may facilitate display, execution, interaction, manipulation, or operation of program components through textual or graphical facilities. For example, user interfaces may provide computer interaction interface elements on a display system operatively connected to the knowledge management computing device 60, such as cursors, icons, check boxes, menus, scrollers, windows, widgets, by way of example only. Graphical user interfaces (GUIs) may be employed, including, without limitation, Apple Macintosh operating systems' Aqua, IBM OS/2, Microsoft Windows (e.g., Aero, Metro, by way of example only.), Unix X-Windows, web interface libraries (e.g., ActiveX, Java, Javascript, AJAX, HTML, Adobe Flash, by way of example only.), or the like.

In some embodiments, the knowledge management computing device 60 may implement a web browser 36 stored program component. The web browser 36 may be a hypertext viewing application, such as Microsoft Internet Explorer, Google Chrome, Mozilla Firefox, Apple Safari, by way of example only. Secure web browsing may be provided using HTTPS (secure hypertext transport protocol), secure sockets layer (SSL), Transport Layer Security (TLS), by way of example only. Web browser 36 may utilize facilities, such as AJAX, DHTML, Adobe Flash, JavaScript, Java, application programming interfaces (APIs), by way of example only. In some embodiments, the knowledge management computing device 60 may implement a mail server 34 stored program component. The mail server may be an Internet mail server, such as Microsoft Exchange, although other types and/or numbers of mail server systems may be used. The mail server may utilize facilities such as ASP, ActiveX, ANSI C++/C#, Microsoft .NET, CGI scripts, Java, JavaScript, PERL, PHP, Python, WebObjects, by way of example only. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the knowledge management computing device 60 may implement a mail client 32 stored program component. The mail client 32 may be a mail viewing application, such as Apple Mail, Microsoft Entourage, Microsoft Outlook, Mozilla Thunderbird, by way of example only.

In some embodiments, knowledge management computing device 60 may store user/application data 30, such as the data, variables, records, by way of example only. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, by way of example only.). Such databases may be consolidated or distributed, sometimes among the various computer systems discussed above in this disclosure. It is to be understood that the structure and operation of the any computer or database component may be combined, consolidated, or distributed in any working combination.

An exemplary method for calculating customer satisfaction score for a knowledge management system will now be described with reference to FIGS. 1-3. The exemplary method comprises calculating a knowledge artifact score for a plurality of knowledge artifacts, a customer satisfaction index for a plurality of knowledge artifacts and a customer feedback score for the knowledge management system by the knowledge management computing device 60, based on a newness value, utility value, knowledge artifact quality, customer artifact experience for the plurality of knowledge artifacts and knowledge management system performance score and customer system experience score for the knowledge management system. The exemplary method further comprises calculating a total customer satisfaction score for the knowledge management system, based on the calculated knowledge artifact score, customer satisfaction index and the customer feedback score.

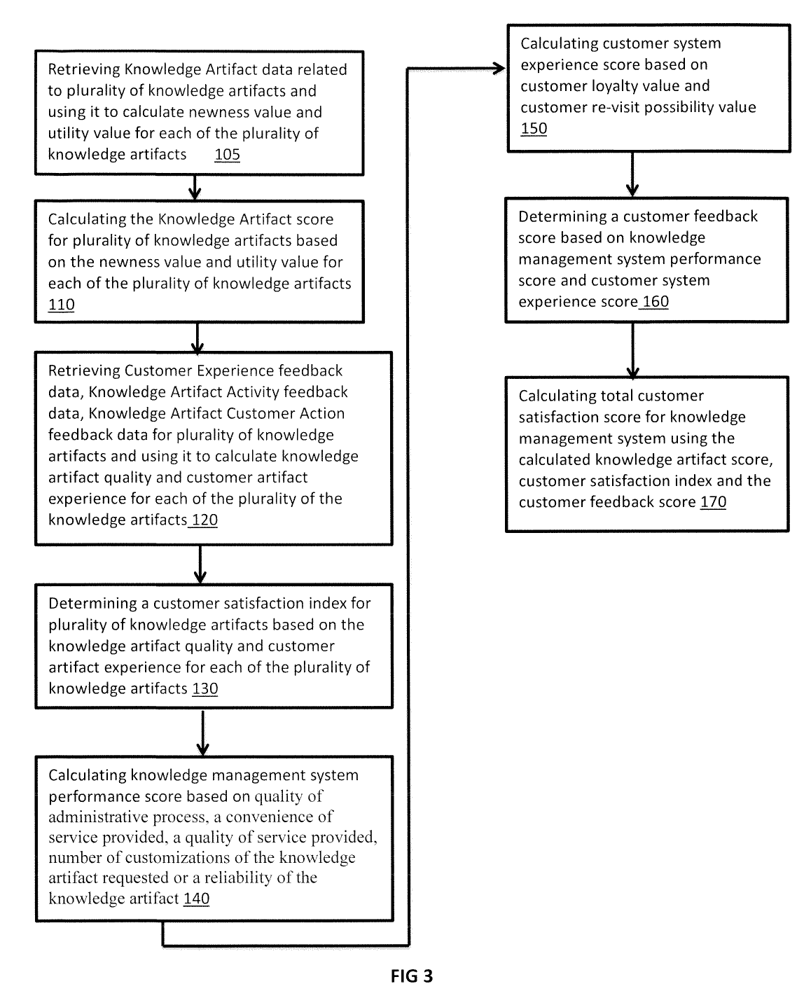

The exemplary method begins at step 105 of FIG. 3 where the knowledge management computing device 60 receives a knowledge artifact data related to a plurality of knowledge artifacts present in the knowledge management system. A user, who can be either an employee or supplier or customer can access and interact with the knowledge management computing device 60 through standard communication network 65 like the internet, telecommunication lines using a web portal or a typical stand-alone application that is housed within the company premises and having access to the company's internal data and applications. In some embodiments, the knowledge management computing device 60 may store data like a database or have access to the stored data in a separate database which includes but not restricted to knowledge artifact data, customer system experience data, customer experience feedback data, knowledge artifact activity feedback data, knowledge artifact customer action feedback data and knowledge management system performance data. The knowledge management computing device 60 will also act as a database storing the results of all the data transformation and score calculations towards the various parameters leading to the total customer satisfaction score of the knowledge management system. As an example the knowledge artifact data can include at least one of a country of knowledge artifact creation, a language of knowledge artifact creation, a user type, one or more tags having reference key words or a hierarchical group of categories. The knowledge management system houses a plurality of knowledge artifacts that are uploaded or saved in the knowledge management system by users like employees, vendors or suppliers. The users while uploading the knowledge artifacts also add tags of reference words, which form a part of the knowledge artifact data that define the categories of the knowledge artifact. Subsequent to the uploading of knowledge artifact into the knowledge management system, categorization of the knowledge artifact is carried out by the knowledge management computing device 60 based on the detail provided in the knowledge artifact data. The knowledge management computing device 60, then searches or queries the knowledge management database, where the knowledge artifact data for all knowledge artifacts are stored previously, for a match to the tags entered by the user for the newly uploaded knowledge artifact. Based on the return value for this search and prior set rules and stored data, a knowledge artifact score is assigned to the newly uploaded artifact. As an example, if the search on the knowledge management database against the tags of a newly uploaded knowledge artifact returns zero results of already present similar tags, this would mean that the knowledge artifact has a high newness value and a high utility value, and hence would get a knowledge score of 100. Similarly, if the search on the knowledge management database returns very few results but of very little relevance to user, this would mean that the knowledge artifact has an above average newness value and medium utility value and hence would get a knowledge score of 80. Again, if the search on the knowledge management database returns an above average number of results, e.g. a number above an average threshold, but not in order of importance to user, this would mean that the knowledge artifact has an above average newness value and low utility value and hence would get a knowledge score of 60. And finally, as an example, if the search on the knowledge management database returns very high number of results but of very little relevance to user, this would mean that the knowledge artifact has a low newness value and low utility value and hence would get a knowledge score of 40. The newness value and utility value is calculated by the knowledge management database based on a prior set of rules and a standard semantic analyzer to compare the results in order to verify their similarities. Finally, as an example, the knowledge score for the plurality of knowledge artifacts are combined together in a simple summation or addition of individual knowledge scores to provide a knowledge score for the plurality of knowledge artifacts as described in step 110 of FIG. 3, although other manners for obtaining the knowledge score could be used.

Post the calculation of the knowledge score for the plurality of knowledge artifacts, the knowledge management computing device 60 determines a customer satisfaction index for a plurality of knowledge artifacts based on knowledge artifact quality and customer artifact experience as described in step 130 of FIG. 3. As an example, customer satisfaction index is determined by the knowledge management computing device 60, based on knowledge artifact quality and customer artifact experience. Both the knowledge artifact quality and customer artifact experience are calculated based on multiple feedback surveys collected from users, feedback retrieved by the knowledge management system on the user interaction with knowledge artifacts on the system and feedback retrieved by the knowledge management system on the various activities occurring on a knowledge artifact as described in step 120 of FIG. 3.

As an example, the knowledge management computing device 60 interacts with the user and the knowledge artifacts in the knowledge management system in multiple ways. Initially, the knowledge management computing device 60 provides feedback surveys to users to obtain the effectiveness of the knowledge artifact queried for and received by the user. Effectiveness here, as an example, can be typically measured on a scale of 1 to 10 with 10 being a maximum score.

Additionally, the knowledge management computing device 60 stores and analyzes, using a standard semantic analyzer, various user interactions amongst themselves on the knowledge artifact using applicative approaches, like chat systems or message boards, to further determine effectiveness of the knowledge artifact. Effectiveness here again can be typically measured on a scale of 1 to 10 with 10 being a maximum score by way of example.

Next, the knowledge management computing device 60 also stores data on whether issues raised by a user via a search query on the knowledge management system, regarding a specific knowledge artifact need was resolved successfully or not. This is done by a feedback survey and by analyzing the user search interactions on the knowledge management system. The knowledge management computing device 60 also marks a knowledge artifact which has successfully resolved a user search query to the user's satisfaction, as a tradable asset in the knowledge management system.

Based on the above methodologies, by way of an example, the knowledge management computing device 60, collects and determines parameters relating to knowledge artifact and user interaction, not restricting to, value of the knowledge artifact, user perception of utility value of knowledge artifact, number of common touch-points created on a knowledge artifact, relevancy of search done by user, ranking of the search done by user, number of user downloads on the knowledge artifact, number of likes provided by users on the knowledge artifact, knowledge artifact accuracy and format and efficiency of response by knowledge management system to resolve issues faced by user. The above mentioned parameters are collected and stored by the knowledge management computing device 60 forming a part of the customer experience feedback data, knowledge artifact activity feedback data and knowledge artifact customer action feedback data.

In this example, knowledge artifact quality is calculated based on one or more of the above mentioned parameters, like value of the knowledge artifact, number of common touch-points created on a knowledge artifact, number of user downloads on the knowledge artifact, number of likes provided by users on the knowledge artifact and knowledge artifact accuracy and format. Additionally, in this example, customer artifact experience is calculated based on the remaining of the above mentioned parameters, like user perception of utility value of knowledge artifact, relevancy of search done by user, ranking of the search done by user and efficiency of response by knowledge management system to resolve issues faced by user. As an example, the value of a knowledge artifact is determined by the measure of technical mistakes present in that knowledge artifact which is provided by user as a part of the feedback survey. A user could classify the knowledge artifact as low, medium or high quality which would have an equivalent value of 0, 5 and 10 respectively. Similarly, as an example, a common touch point is defined by the number of users that have referenced the knowledge artifact as captured by the knowledge management computing device 60 which will be a measure of the knowledge artifact's reusability.

Similarly, content accuracy is defined as a measure of the accuracy of the document, which is captured in a survey rolled out to users, on how close the content of the document is in solving a given problem. As an example, possible values for content accuracy as provided by users in a survey can be 0 when content is misguiding and cannot solve the problem, 5 when content is partially right and solve problem partially and 10 when content is exactly what is required to solve the problem.

Similarly content format is defined by the readability of the knowledge artifact and how structured the content has been arranged for reading which is provided by the user through feedback surveys and has two values, 0 for not readable and 1 for readable. As an example, User perception on usefulness of the knowledge artifact is defined as the usefulness of the knowledge artifact as perceived by the user which is provided through feedback surveys as values 0, which is not useful and 1 which is useful.

Similarly, by way of an example, search relevancy is defined as how relevant were the search results to the user, provided by user through feedback surveys, having values of 0 for not being relevant and 1 for being relevant. In this example, search ranking is determined by the knowledge management computing device 60, based on the retrieved results against a user search based on context like keywords used in search string, hyperlinks and interconnectivity between results retrieved and user interface criteria like search history. This is typically carried out by the knowledge management computing device 60, using standard tools like a semantic analyzer, natural language analyzer to identify user profile and needs to rank the results accordingly. The minimum value for the search ranking parameter, as provided by the knowledge management computing device 60 is 1. By way of an example, a user in a corporate environment, querying for “Blackberry” would make the knowledge management computing device 60, rank the retrieved result concerning the mobile instrument higher than the fruit with the same name.

As a part of the interaction of user with the knowledge management system, users can raise queries to the knowledge management computing device 60 about knowledge artifacts which can get resolved by subject matter experts (SME) within the knowledge management system using interactive methods like chat or video conferencing. Timeliness of response to a user query on a knowledge artifact refers to the time taken by a SME to respond to all the queries on the knowledge artifact. It is measured by the knowledge management computing device 60, as an average time taken to resolve all queries pertaining to the knowledge artifact. As an example, if the average time for response is calculated to be >48 hours, the timeliness of response value is rated as 0 while if average time for response is calculated to be between 24 to 48 hours, the timeliness of response value is rated as 5 and if average time for response is calculated to be between 0 to 24 hours, the timeliness of response value is rated as 10.

Finally the knowledge management computing device 60 calculates the customer satisfaction index for plurality of knowledge artifacts as described in step 130 of FIG. 3, based on the simple summation formula Σ(A+B)/10 where A is summation of parameters under Knowledge Artifact quality and B is summation of parameters under Customer Artifact experience. A is further defined by the formula

$$( {\sum }_{i = 1}^{n} {f}_{y 1} / n ) + ( {\sum }_{i = 1}^{n} {f}_{y 2} / n ) + ( {\sum }_{i = 1}^{n} {f}_{y 3} / n ) + ( {\sum }_{i = 1}^{n} {f}_{y 4} / n ) + ( {\sum }_{i = 1}^{n} {f}_{y 5} / n ) + ( {\sum }_{i = 1}^{n} {f}_{y 6} / n )$$

### Where

fy1=Value of Knowledge Artifact
fy2=Number of common touch-points created on the knowledge artifact
fy3=Number of downloads on the knowledge artifact
fy4=Number of likes provided by users on the knowledge artifact
fy5=Content Accuracy
fy6=Content Format
n=number of users providing input and feedback
And B is defined by the formula

$$( {\sum }_{i = 1}^{n} {f}_{y 7} / n ) + ( {\sum }_{i = 1}^{n} {f}_{y 8} / n ) + ( {\sum }_{i = 1}^{n} {f}_{y 9} / n ) + ( {\sum }_{i = 1}^{n} {f}_{y 10} / n )$$

### Where

fy7=User perception on usefulness of the knowledge artifact
fy8=Search relevancy
fy9=Search ranking
fy10=Timeliness of response to an issue
n=number of users providing input and feedback

Post the calculation of the customer satisfaction index, the knowledge management computing device 60 next determines a customer feedback score for the knowledge management system based on knowledge management system performance score and customer system experience score as described in step 160 of FIG. 3. As an example, customer feedback score is determined by the knowledge management computing device 60, based on knowledge management system performance score and customer system experience score, both of which are calculated based on multiple feedback surveys collected from users, feedback retrieved by the knowledge management system on the user interaction with knowledge artifacts on the system as described in steps 140 and 150 of FIG. 3.

Based on the above methodologies, by way of an example, the knowledge management computing device 60, collects and determines parameters relating to knowledge artifact and user interaction, not restricting to, perception of the user to re-visit the knowledge management system, quality of the administrative process, user loyalty and re-purchase likelihood, number of customizations requested by user on the knowledge artifact, service convenience, quality of service provided and knowledge artifact reliability.

Customer system experience score is calculated based on some of the above mentioned parameters like perception of the user to re-visit the knowledge management system and user loyalty and re-purchase likelihood. Knowledge management system performance score is calculated by the knowledge management computing device 60 based on the remaining of above mentioned parameters like, number of customizations requested by user on the knowledge artifact, quality of the administrative process, service convenience, quality of service provided and knowledge artifact reliability. Perception of the user to re-visit the knowledge management system is provided a value of 0 or 1 marking intention to re-visit or not, through a feedback survey to the user.

Next, as an example, quality of the administrative process is defined as the quality of all the knowledge management activities and administrative processes, which is captured by the knowledge management computing device 60 through a feedback survey provided by the user. The value for the parameter, quality of the administrative process, varies from 0 denoting low quality, 5 denoting medium or average quality and 10 which denotes high quality. Similarly user loyalty and re-purchase likelihood has two values as captured by the feedback survey by user, 0 if the user does not want to re-purchase and 1 if the user will re-purchase.

Similarly, number of customizations requested by user on the knowledge artifact is calculated by the knowledge management computing device 60 based on the change requests and changes made on the knowledge artifact as requested by the users. The minimum value for this parameter is 1 indicating the original unchanged knowledge artifact itself.

Service convenience is captured by the knowledge management computing device 60 based on a part of the feedback surveys rolled out to the users to capture information on how convenient it is to use the knowledge management system and the service that they are receiving on the knowledge management system. Service convenience has two values as provided through the feedback surveys, 0 if user considers it inconvenient and 1 if user considers if it was convenient.

Similarly service quality is captured by the knowledge management computing device 60 based on a part of the feedback surveys rolled out to the users to capture information on the quality of service provided to users on the knowledge portal. Service quality can have 3 values as provided through the feedback surveys, 0 if it is poor service quality, 5 if it is average service quality and 10 if it is good service quality.

Next, Knowledge Reliability is captured by the knowledge management computing device 60 based on a part of the feedback surveys rolled out to the users to capture information on the reliability of the knowledge artifact on the knowledge management system to help in resolving user issues. Knowledge Reliability can have 2 values as provided through the feedback surveys, 0 if it is not reliable and 1 if it is reliable.

Finally the knowledge management computing device 60 calculates the customer feedback score for the knowledge management system as described in step 160 of FIG. 3, based on the simple summation formula Σ(A1+B1)/7 where A1 is summation of parameters under Knowledge management system performance score and B1 is summation of parameters under Customer system experience score. A is further defined by the formula

$$( {\sum }_{i = 1}^{n} {f}_{z 1} / n ) + ( {\sum }_{i = 1}^{n} {f}_{z 2} / n ) + ( {\sum }_{i = 1}^{n} {f}_{z 3} / n ) + ( {\sum }_{i = 1}^{n} {f}_{z 4} / n ) + ( {\sum }_{i = 1}^{n} {f}_{z 5} / n )$$

### Where

fz1=number of customizations requested by user on the knowledge artifact
fz2=quality of the administrative process
fz3=service convenience
fz4=quality of service provided
fz5=knowledge artifact reliability
n=number of users providing input and feedback
And B is defined by the formula

$$( {\sum }_{i = 1}^{n} {f}_{z 6} / n ) + ( {\sum }_{i = 1}^{n} {f}_{z 7} / n )$$

### Where

fz6=perception of the user to re-visit the knowledge management system
fz7=user loyalty and re-purchase likelihood
n=number of users providing input and feedback

Post the calculation of the customer feedback score for the knowledge management system, the knowledge management computing device 60 calculates a total customer satisfaction score for the knowledge management system as described in step 170 of FIG. 3. In this example, the total customer satisfaction score for the knowledge management system is computed by simply summing up the already calculated knowledge artifact score, customer satisfaction index and the customer feedback score and a higher total customer satisfaction score typically indicates a more mature and better working knowledge management system.

The specification has described an example of a method and device for calculating a customer satisfaction score for a knowledge management system. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, and/or deviations, by way of example only, of those described herein) will be apparent to persons skilled in the relevant art(s) based on the teachings contained herein. Such alternatives fall within the scope and spirit of the disclosed embodiments.

Furthermore, one or more non-transitory computer-readable storage media may be utilized in implementing embodiments consistent with the present disclosure. A non-transitory computer-readable storage medium refers to any type of physical memory on which information or data readable by a processor may be stored. Thus, a non-transitory computer-readable storage medium may store instructions for execution by one or more processors, including programmed instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

What is claimed is:

1. A method for calculating customer satisfaction score for a knowledge management system, the method comprising:
calculating, at the knowledge management data server device, a knowledge artifact score for a plurality of knowledge artifacts obtained from an overall set of knowledge artifacts, based on at least one of a newness value or a utility value for each of the plurality of the knowledge artifacts;
determining, at the knowledge management data server device, a customer satisfaction index for the plurality of knowledge artifacts obtained from the overall set of knowledge artifacts, based on at least a knowledge artifact quality and a customer artifact experience;
determining, at the knowledge management data server device, a customer feedback score for the knowledge management system based on at least a knowledge management system performance score and a customer system experience score; and
determining, at the knowledge management data server device, a total customer satisfaction score for the knowledge management system based on the calculated knowledge artifact score for the plurality of knowledge artifacts, the determined customer satisfaction index for the plurality of knowledge artifacts and the determined customer feedback score for the knowledge management system.

2. The method as set forth in claim 1 further comprising:
retrieving, at a knowledge management data server device, knowledge artifact data related to the plurality of knowledge artifacts; and
calculating, at the knowledge management data server device, the newness value and utility value of each of plurality of the knowledge artifacts based on the retrieved knowledge artifact data.

3. The method as set forth in claim 1 further comprising:
retrieving, at the knowledge management data server device, customer experience feedback data, knowledge artifact activity feedback data and knowledge artifact customer action feedback data for the plurality of knowledge artifacts; and
generating, at the knowledge management data server device, the knowledge artifact quality and the customer artifact experience for the plurality of knowledge artifacts, based on at least the retrieved customer experience feedback data, knowledge artifact activity feedback data and knowledge artifact customer action feedback data.

4. The method as set forth in claim 1 wherein the knowledge management system performance score is further calculated based on at least one of a quality of administrative process, a convenience of service provided, a quality of service provided, a number of customizations of the knowledge artifact requested or a reliability of the knowledge artifact.

5. The method as set forth in claim 1 wherein the customer system experience score is further calculated based on at least one of a customer loyalty value or a customer re-visit possibility value.

6. The method as set forth in claim 5 wherein the customer re-visit possibility value is based on at least one of a number of tradable knowledge artifacts or a utility value of tradable knowledge artifacts.

7. The method as set forth in claim 2 wherein the knowledge artifact data comprises at least one of a country of knowledge artifact creation, a language of knowledge artifact creation, a user type, one or more tags or a hierarchical group of categories defining one of the plurality of the knowledge artifacts.

8. A knowledge management computing device, comprising:
a memory; and
a processor coupled to the memory and configured to execute programmed instructions stored in the memory, comprising:
calculating a knowledge artifact score for a plurality of knowledge artifacts obtained from an overall set of knowledge artifacts, based on at least one of a newness value or a utility value for each of the plurality of the knowledge artifacts;
determining a customer satisfaction index for the plurality of knowledge artifacts obtained from the overall set of knowledge artifacts, based on at least a knowledge artifact quality and a customer artifact experience;
determining a customer feedback score for the knowledge management system based on at least a knowledge management system performance score and a customer system experience score; and
determining a total customer satisfaction score for the knowledge management system based on the calculated knowledge artifact score for the plurality of knowledge artifacts, the determined customer satisfaction index for the plurality of knowledge artifacts and the determined customer feedback score for the knowledge management system.

9. The device of claim 8, wherein the processor is further configured to execute programmed instructions stored in the memory for the calculating, further comprises:
retrieving knowledge artifact data related to the plurality of knowledge artifacts; and
calculating the newness value and utility value of each of the plurality of the knowledge artifacts based on the retrieved knowledge artifact data.

10. The device of claim 8, wherein the processor is further configured to execute programmed instructions stored in the memory for the determining, further comprises:
retrieving customer experience feedback data, knowledge artifact activity feedback data and knowledge artifact customer action feedback data for the plurality of knowledge artifacts; and
generating the knowledge artifact quality and the customer artifact experience for the plurality of knowledge artifacts, based on at least the retrieved customer experience feedback data, knowledge artifact activity feedback data and knowledge artifact customer action feedback data.

11. The device of claim 8, wherein the processor is further configured to execute programmed instructions stored in the memory for the determining, wherein the knowledge management system performance score is further calculated based on at least one of a quality of administrative process, a convenience of service provided, a quality of service provided, a number of customizations of the knowledge artifact requested or a reliability of the knowledge artifact.

12. The device of claim 8, wherein the customer system experience score is further calculated based on at least one of a customer loyalty value or a customer re-visit possibility value.

13. The device of claim 12, wherein the customer re-visit possibility value is based on at least one of a number of tradable knowledge artifacts or a utility value of tradable knowledge artifacts.

14. The device of claim 9, wherein the knowledge artifact data comprises at least one of a country of knowledge artifact creation, a language of knowledge artifact creation, a user type, one or more tags or a hierarchical group of categories defining one of the plurality of the knowledge artifacts.

15. A non-transitory computer readable medium having stored thereon instructions for calculating customer satisfaction score for a knowledge management system, comprising machine executable code which when executed by a processor, causes the processor to perform steps comprising:
calculating a knowledge artifact score for a plurality of knowledge artifacts obtained from an overall set of knowledge artifacts, based on at least one of a newness value or a utility value for each of the plurality of the knowledge artifacts;
determining a customer satisfaction index for the plurality of knowledge artifacts obtained from the overall set of knowledge artifacts, based on at least a knowledge artifact quality and a customer artifact experience;
determining a customer feedback score for the knowledge management system based on at least a knowledge management system performance score and a customer system experience score; and
determining a total customer satisfaction score for the knowledge management system based on the calculated knowledge artifact score for the plurality of knowledge artifacts, the determined customer satisfaction index for the plurality of knowledge artifacts and the determined customer feedback score for the knowledge management system.

16. The medium of claim 15, wherein the processor is further configured to execute programmed instructions stored in the memory for the calculating, further comprises:
retrieving the knowledge artifact data, related to the plurality of knowledge artifacts; and
calculating the newness value and utility value of each of the plurality of the knowledge artifacts based on the retrieved knowledge artifact data.

17. The medium of claim 15, wherein the processor is further configured to execute programmed instructions stored in the memory for the determining, further comprises:
retrieving customer experience feedback data, knowledge artifact activity feedback data and knowledge artifact customer action feedback data for the plurality of knowledge artifacts; and
generating the knowledge artifact quality and the customer artifact experience for the plurality of knowledge artifacts, based on at least the retrieved customer experience feedback data, knowledge artifact activity feedback data and knowledge artifact customer action feedback data.

18. The medium of claim 15, wherein the processor is further configured to execute programmed instructions stored in the memory for the determining, wherein the knowledge management system performance score is further calculated based on at least one of a quality of administrative process, a convenience of service provided, a quality of service provided, a number of customizations of the knowledge artifact requested or a reliability of the knowledge artifact.

19. The medium of claim 15, wherein the processor is further configured to execute programmed instructions stored in the memory for the determining, wherein the customer system experience score is further calculated based on at least one of a customer loyalty value or a customer re-visit possibility value.

20. The medium of claim 19, wherein the customer re-visit possibility value is based on at least one of a number of tradable knowledge artifacts or a utility value of tradable knowledge artifacts.

21. The medium of claim 16, wherein the knowledge artifact data comprises at least one of a country of knowledge artifact creation, a language of knowledge artifact creation, a user type, one or more tags or a hierarchical group of categories defining one of the plurality of the knowledge artifacts.
